(19) United States
(12) Patent Application Publication
(10) Pub. No.: US 2016/0118838 A1
(43) Pub. Date: Apr. 28, 2016

(54) WIRELESS CHARGING DEVICE AND ELECTRONIC DEVICE ASSEMBLY WITH WIRELESS CHARGING DEVICE

(71) Applicants: HONG FU JIN PRECISION INDUSTRY (WUHAN) CO., LTD., Wuhan (CN); HON HAI PRECISION INDUSTRY CO., LTD., New Taipei (TW)

(72) Inventor: GUANG-FENG OU, Wuhan (CN)

(21) Appl. No.: 14/530,011

(22) Filed: Oct. 31, 2014

(30) Foreign Application Priority Data
Oct. 22, 2014 (CN) 201410565550.8

(51) Int. Cl. H02J 7/02; H02J 7/00

(52) U.S. Cl. CPC H02J 7/025; H02J 7/0044; H02J 7/007

(57) ABSTRACT

A wireless charging device charging for an electronic device is disclosed. The wireless charging device includes a control unit, a sending coil coupled to the control unit, and a range sensor coupled to the control unit. The sending coil generates an induced magnetic field accepted by the electronic device. The range sensor senses a distance between a user and the wireless charging device, and further configured to determine if the sensed distance is greater than a preset distance. The sensed distance is greater than the preset distance, the control unit supplies power for the sending coil, and the sending coil generates the induced magnetic field. The sensed distance is smaller than a preset distance, the control unit stops to supply power for the sending coil, and the sending coil stops to generate the induced magnetic field.

### CROSS-REFERENCE TO RELATED APPLICATIONS

This application claims priority to Chinese Patent Application No. 201410565550.8 filed on Oct. 22, 2014, the contents of which are incorporated by reference herein.

### FIELD

The subject matter herein generally relates to an electronic device assembly with a wireless charging device.

### BACKGROUND

Wireless charging devices are widely used in an electronic industry and may generate electromagnetic radiation which is harmful for an end user.

### BRIEF DESCRIPTION OF THE DRAWINGS

Implementations of the present technology will now be described, by way of example only, with reference to the attached figures.

FIG. 1 is an exploded, isometric view of an electronic device, a wireless charging device, and a desk.

FIG. 2 is an assembled view of the electronic device, the wireless charging device and the desk of FIG. 1.

FIG. 3 is a block diagram of the wireless charging device and the electronic device of FIG. 1.

FIG. 4 is a flowchart showing one embodiment of a wireless charging method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

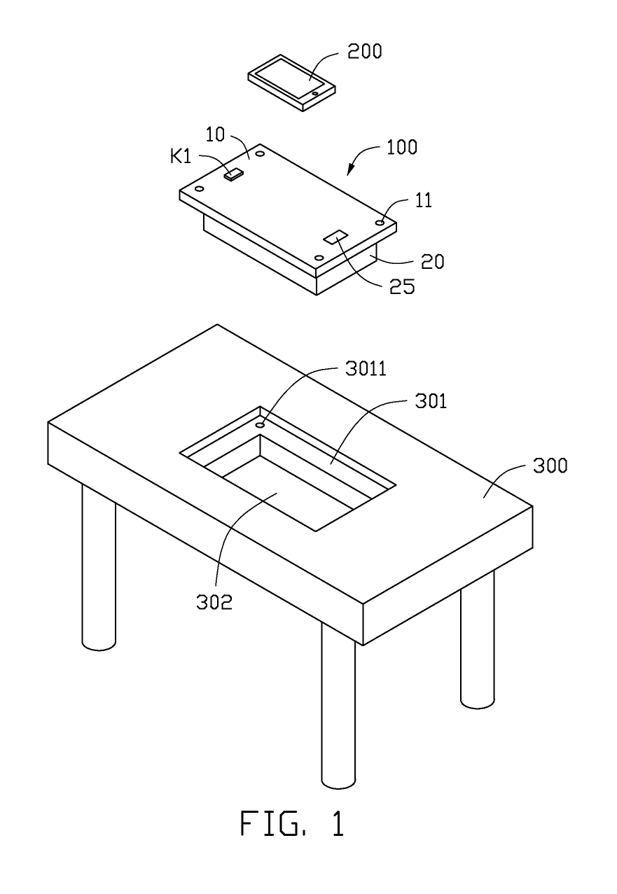

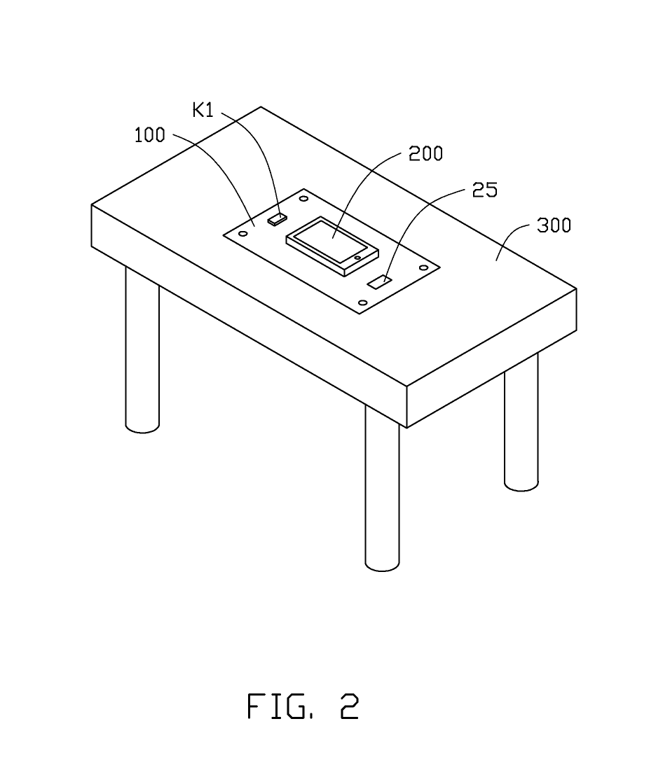

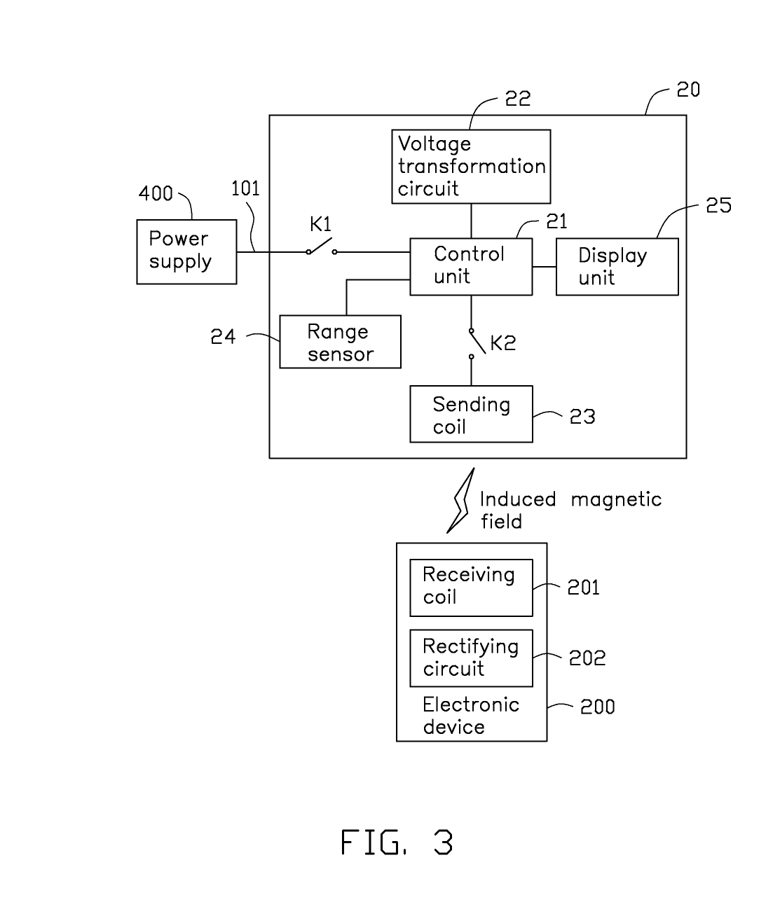

FIGS. 1-3 illustrate an electronic device assembly in accordance with one embodiment. The wireless charging device 100 can include a wireless charging device 100, an electronic device 200, a desk 300, and a power supply 400.

The wireless charging device 100 can be installed on the desk 300 and can charge for the electronic device 200. In at least one embodiment, the electronic device 200 may be a mobile phone, a personal digital assistant, and so on. The wireless charging device 100 can be coupled to the power supply 400 and can include a mounting board 10 and a control box 20 integrated with the mounting board 10. The mounting box 10 can define four mounting holes 11, and the four mounting holes 11 are arranged at four corner of the mounting.

The wireless charging device 100 can further include a control unit 21, a voltage transformation circuit 22, a sending coil 23, a range sensor 24, and a display unit 25 located in the control box 20. The control unit 21 can be coupled to the power supply 400 via a first switch K1. The voltage transformation circuit 22 and the sending coil 23 are separately coupled to the control unit 21. The power supply 400 can output a voltage signal for the wireless charging device 200, and the voltage transformation circuit 22 converts the voltage signal to a preset voltage. The sending coil 23 can generate an induced magnetic field received by the electronic device 200 and is coupled to the control unit 21 via a second switch K2. The control unit can 21 can switch on or off the second switch K2.

The range sensor 24 is coupled to control unit 21 can measure a distance between a user and the wireless charging device 100. In at least one embodiment, the range sensor 24 is an infrared sensor, and the infrared sensor can have a sending tube and a receiving tube. The sending tube can send an infrared signal, and the receiving tube can receive the infrared signal. When the infrared signal encounters obstacle, the infrared signal can be reflected so that the receiving tube can receive the infrared signal. The control unit 21 can power off the wireless charging device 100 upon receiving the infrared signal.

The display unit 25 can display the charging status of the electronic device 200. In at least one embodiment, the display unit 25 may be a light-emitting diode (LED). When the electronic device 200 is in a charging state, the LED can emit red light. When the charging is completed or the electronic device 200 is not in a charging state, the LED can emit green light.

The electronic device 200 can include a receiving coil 201 and a rectifying circuit 201. The receiving coil 201 can receive the infrared signal generated by the sending coil 201. The receiving coil 201 can generate an electric current upon inducting the induced magnetic field generated by the sending coil. The rectifying circuit can convert the generated current to a preset direct current.

The desk 300 can include a supporting board 301, and the supporting board 301 defines a recess 302 for receiving the wireless charging device 100. A bottom portion of the recess 302 defines four installation holes 3011 corresponding to the four mounting holes 11.

In assembly, the control box 20 is received in the recess 302. Four fastens, such as screwing, bolting, and so on, are locked into the four mounting holes 11 and the four installation holes 3011, to secure the wireless charging device 100 to the desk 300.

The electronic device 200 is placed above the mounting board 10 of the wireless charging device 100. The first switch K1 is switched on. The range sensor 24 can sense a distance between a use and the wireless charging device 100 and can determine if the sensed distance is greater than a preset distance. When the range sensor 24 senses the sensed distance is not greater than a preset distance, the control unit 21 can switch off the second switch K2. The control unit 21 stops supplying power for the sending coil 23. The sending coil 23 stops generating the induced magnetic field. The wireless charging device 100 stops charging for the electronic device 200.

When the sensed distance is greater than the preset distance, the control unit 21 switch on the second switch K2. The control unit 21 supplies power for the sending coil 23. The sending coil 23 generates the induced magnetic field. The receiving coil 201 can induct the induced magnetic field to generate electric current. The rectifying circuit can convert the generated current to the preset direct current charging for the electronic device 200.

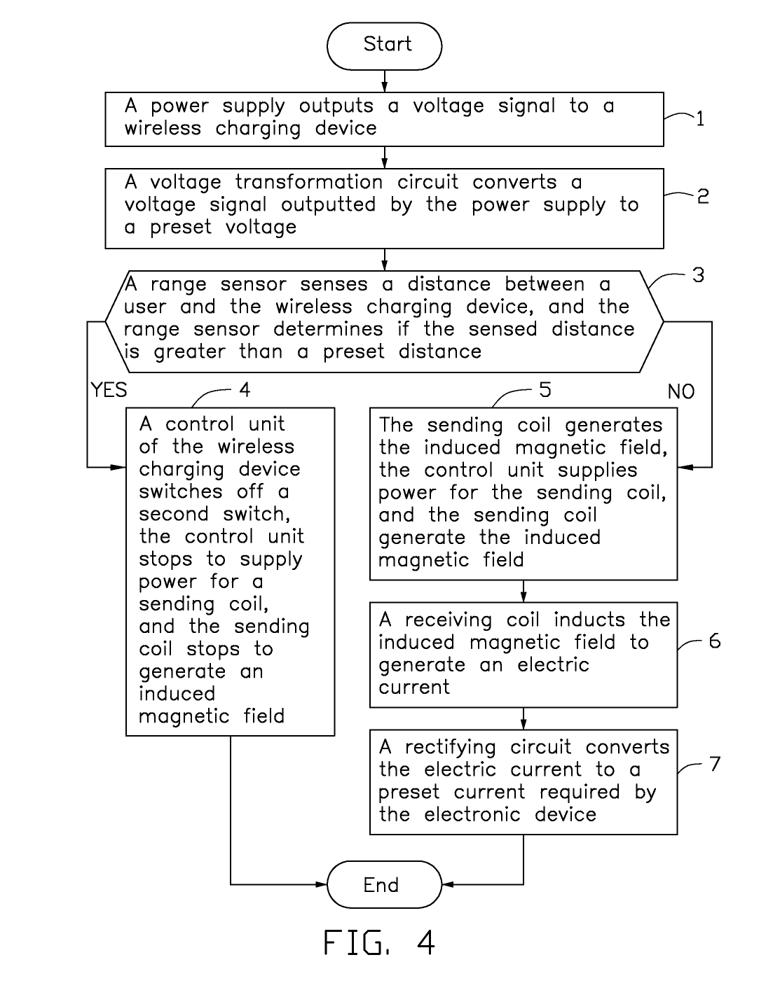

Referring to FIG. 4, a flowchart is presented in accordance with an example embodiment of a wireless charging method. The example method is provided by way of example, as there are a variety of ways to carry out the method. The method described below can be carried out using the configurations illustrated in FIGS. 1-3, for example, and various elements of these figures are referenced in explaining the example method. Each block shown in FIG. 4 represents one or more processes, methods or subroutines, carried out in the example method. Furthermore, the illustrated order of blocks is illustrative only and the order of the blocks can change according to the present disclosure. Additional blocks can be added or fewer blocks may be utilized, without departing from this disclosure. The example method can begin at block 1.

At block 1, a power supply outputs a voltage signal to a wireless charging device. The power supply is coupled to the wireless charging device via a first switch.

At block 2, a voltage transformation circuit converts a voltage signal outputted by the power supply to a preset voltage.

At block 3, a range sensor senses a distance between a user and the wireless charging device, and the range sensor determines if the sensed distance is greater than a preset distance. When the sensed distance is not greater than a preset distance, the method can go to block 4. When the sensed distance is greater than the preset distance, the method can go to block 5.

At block 4, a control unit of the wireless charging device switches off a second switch. The control unit stops supplying power for a sending coil, and the sending coil stops generating an induced magnetic field.

At block 5, the control unit switches on the second switch. The control unit supplies power for the sending coil, and the sending coil generate the induced magnetic field.

At block 6, a receiving coil inducts the induced magnetic field to generate an electric current.

At block 7, a rectifying circuit converts the electric current to a preset current required by the electronic device.

The embodiments shown and described above are only examples. Many details are often found in the art such as the other features of a wireless charging device. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A wireless charging device charging for an electronic device, the wireless charging device comprising:
a control unit;
a sending coil coupled to the control unit, the sending coil configured to generate an induced magnetic field to charge an electronic device; and
a range sensor coupled to the control unit, the range sensor configured to sense a distance between a user and the wireless charging device, the range sensor further configured to determine if the sensed distance is greater than a preset distance such that when the sensed distance is greater than the preset distance, the control unit is configured to supply power for the sending coil and the sending coil is configured to generate the induced magnetic field, and when the sensed distance is not greater than the preset distance, the control unit is configured to refrain from supplying power for the sending coil and the sending coil is configured to refrain from generating the induced magnetic field.

2. The wireless charging device of claim 1, wherein the control unit is coupled to the sending coil via a switch; when the sensed distance is greater than the preset distance, the switch is switched on; and when the sensed distance is not greater than the preset distance, and the switch is switched off.

3. The wireless charging device of claim 1, further comprising a display unit, wherein the display unit is coupled to the control unit, and the display unit is configured to display a charging status of the wireless charging device.

4. An electronic device assembly comprising:
an electronic device;
a power supply; and
a wireless charging device charging for the electronic device, and the wireless charging device comprising:
a control unit;
a sending coil coupled to the control unit;
a range sensor coupled to the control unit,
wherein the power supply is configured to supply power for the control unit; the sending coil is configured to generate an induced magnetic field accepted by the electronic device, the range sensor is configured to sense a distance between a user and the wireless charging device, and the range sensor is further configured to determine if the sensed distance is greater than a preset distance;
when the sensed distance is greater than the preset distance, the control unit is configured to supply power for the sending coil, and the sending coil is configured to generate the induced magnetic field; and
when the sensed distance is smaller than a preset distance, the control unit is configured to stop to supply power for the sending coil, and the sending coil is configured to stop to generate the induced magnetic field.

5. The electronic device assembly of claim 4, wherein the power supply is coupled to the control unit via a first switch.

6. The electronic device assembly of claim 4, wherein the control unit is coupled to the sending coil via a switch; when the sensed distance is greater than the preset distance, the switch is switched on; and when the sensed distance is smaller than the preset distance, and the switch is switched off.

7. The electronic device assembly of claim 4, further comprising a display unit, wherein the display unit is coupled to the control unit, and the display unit is configured to display a charging status of the wireless charging device.

8. The electronic device assembly of claim 4, wherein the electronic device comprises a receiving coil, when the sensed distance is greater than the preset distance, the receiving coil is configured to induct the induced magnetic field and generate an electric current.

9. The electronic device assembly of claim 8, wherein electronic device further comprises a rectifying circuit, and the rectifying circuit is configured to convert the electronic current to a preset current accepted by the electronic device.

10. The electronic device assembly of claim 7, further comprising a desk, wherein the wireless charging device comprises a mounting board, the wireless charging device is received in the desk, and the electronic device is placed on the mounting board.

11. The electronic device assembly of claim 10, wherein the display unit is a light emitting diode.

12. The electronic device assembly of claim 10, wherein the light emitting diode is installed on the mounting board.

13. An electronic device assembly comprising:
an electronic device;
a wireless charging device charging for the electronic device, the wireless charging device comprising:
a control unit;
a sending coil coupled to the control unit, the sending coil configured to generate an induced magnetic field accepted by the electronic device; and
a range sensor coupled to the control unit, the range sensor configured to sense a distance between a user and the wireless charging device; and
a power supply configured to supply power for the control unit,
wherein when the sensed distance is greater than a preset distance, the control unit is configured to supply power for the sending coil, and the sending coil is configured to generate the induced magnetic field, and when the sensed distance is less than the preset distance, the control unit is configured to refrain from supplying power for the sending coil, and the sending coil is configured to refrain from generating the induced magnetic field.

14. The electronic device assembly of claim 13, wherein the power supply is coupled to the control unit via a first switch.

15. The electronic device assembly of claim 13, wherein the control unit is coupled to the sending coil via a switch; when the sensed distance is greater than the preset distance, the switch is switched on; and when the sensed distance is smaller than the preset distance, and the switch is switched off.

16. The electronic device assembly of claim 13, further comprising a display unit, wherein the display unit is coupled to the control unit, and the display unit is configured to display a charging status of the wireless charging device.

17. The electronic device assembly of claim 13, wherein the electronic device comprises a receiving coil, when the sensed distance is greater than the preset distance, the receiving coil is configured to induct the induced magnetic field and generate an electric current.

18. The electronic device assembly of claim 13, wherein electronic device further comprises a rectifying circuit, and the rectifying circuit is configured to convert the electronic current to a preset current accepted by the electronic device.

19. The electronic device assembly of claim 16, further comprising a desk, wherein the wireless charging device comprises a mounting board, the wireless charging device is received in the desk, and the electronic device is placed on the mounting board.

20. The electronic device assembly of claim 19, wherein the display unit is a light emitting diode, and the light emitting diode is installed on the mounting board.
